(19) United States
(12) Patent Application Publication
(10) Pub. No.: US 2025/0326186 A1
(43) Pub. Date: Oct. 23, 2025

(54) POROUS STRUCTURAL THERMOSET MATERIAL AND METHOD

(71) Applicant: Schlumberger Technology Corporation, Sugar Land, TX (US)

(72) Inventors: Pratheek Bagivalu Prasanna, Lawrence, KS (US); Luke Macfarlan, Lawrence, KS (US); William K. Goertzen, Lawrence, KS (US); Vinay Joshi, Lawrence, KS (US)

(21) Appl. No.: 19/187,576

(22) Filed: Apr. 23, 2025

Related U.S. Application Data
(60) Provisional application No. 63/637,543, filed on Apr. 23, 2024.
(60) Provisional application No. 63/674,643, filed on Jul. 23, 2024.

(51) Int. Cl. B29C 67/20; B29K 101/10; B29K 105/04; B29K 509/00

(52) U.S. Cl. CPC B29C 67/202; B29K 2101/10; B29K 2105/04; B29K 2509/00

(57) ABSTRACT

A porous structural thermoset media and corresponding methods associated therewith is described herein. A method includes dispensing a removable material into a mold, providing mechanical vibration to the mold to compact the removable material into compacted removable material having a first particle volume fraction, providing a mechanical force to the compacted removable material to generate compacted removable material having a second particle volume fraction that is more than the particle volume fraction, dispensing a structural thermoset material into the mold, curing the structural thermoset material having particles of the compacted removable material disposed therein to generate a cured structural thermoset material having the particles of the compacted removable material disposed therein, and removing the particles of the compacted removable material from the cured structural thermoset material to generate a porous structural thermoset material.

### CROSS-REFERENCE TO RELATED APPLICATIONS

This application claims priority to US Provisional Patent Application having Ser. No. 63/637,543, which was filed on Apr. 23, 2024 and U.S. Provisional Patent Application having Ser. No. 63/674,643, which was filed on Jul. 23, 2024, each of which is incorporated herein by reference in its entirety.

### BACKGROUND

The present disclosure generally relates to porous structural thermoset media.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

In many hydrocarbon wells, inflowing fluid passes through a sand screen which filters out particulates from the inflowing oil or gas. The sand screen prevents sand from entering the wellbore and reduces damage that may occur by erosion. Conventionally, sand screens are made with a metallic mesh material. Once the sand screen is placed into the wellbore, gravel packs are pumped to fill the annulus between the screen and the formation.

In other instances, some metallic sand screens are expandable and are expanded downhole after placement in the wellbore. The result is a reduction in the annulus between the screen and the formation. The expandable screens in many instances have a limited expansion ratio, and the ability of the expandable screen to conform to borehole irregularities may not be satisfactory. Further, the ability of the expandable sand screen to resist borehole collapse may be reduced. Conventional sand screens are rated to resist greater external pressure than expandable sand screens. Expandable sand screens resist less external pressure because of plastic deformation experienced by their metallic components.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a sectional view of a sand screen positioned in a wellbore, in accordance with an embodiment of the present disclosure;

FIG. 2 is a first embodiment of a method of generating the porous structural thermoset material of FIG. 1, in accordance with an embodiment of the present disclosure;

FIG. 3 is a second embodiment of a method of generating the porous structural thermoset material 110 of FIG. 1, in accordance with an embodiment of the present disclosure; and

FIG. 4 a third embodiment of a method of generating the porous structural thermoset material 110 of FIG. 1, in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled) and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Present embodiments described herein generally relate to making and using a porous structural thermoset material. In some embodiments, this porous structural thermoset material can be used in sand control applications, among other applications. For example, one or more embodiments of the present disclosure relate to a porous structural thermoset material that is able to expand once deployed downhole to conform to an irregularly shaped wellbore for sand control operations. As further described below, the porous structural thermoset material according to one or more embodiments of the present disclosure exhibits permeability, robustness, and an expansion ratio that are favorable for sand control operations by allowing for support of the formation during the production of oil.

Embodiments herein of present techniques and generated porous structural thermoset material have advantages to techniques of mixing dissolvable particles into resin, in which it is very difficult to create and network the resultant product as they tend to reduce processability due to increased viscosity of the mixture. Present techniques described herein include a true injection or resin infusion process around the scaffold of the dissolvable network whereas mixing in dissolvable particles will tend to limit porosity and coat the dissolvable particles (making it difficult to remove after curing).

The porous structural thermoset material utilized herein can include a network of pores inside of the structural thermoset material. Furthermore, techniques described herein allow for the generation of porous structural thermoset material, in a geometry which can be a used a sand screen, and that is compressible. The present techniques can be performed on the surface (e.g., not downhole), as this maximizes consistency, increases porosity, and allows for more clearance during any running in hole (RIH) operation. With increased porosity, the porous structural thermoset material can be compressed uphole to a smaller diameter for RIH operations. This is in contrast to other techniques, which can involve attempts to dissolve components of a sand screen downhole, which requires more physical space and is more difficult to control relative to the present techniques and the porous structural thermoset material.

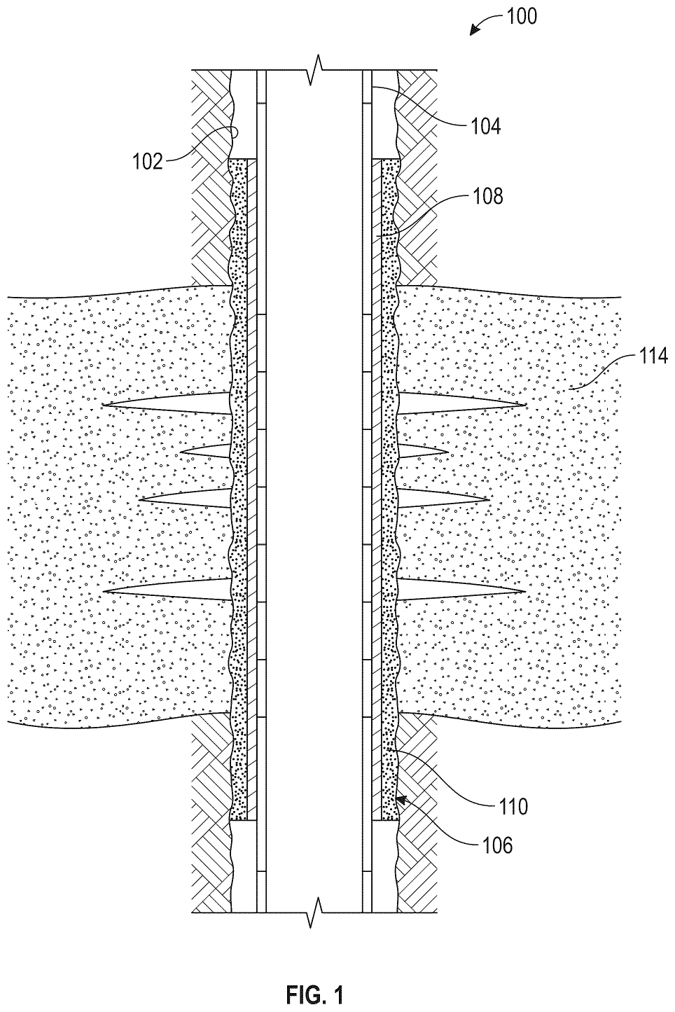

With the foregoing in mind, FIG. 1 is a sectional view of a sand screen positioned in a wellbore according to one or more embodiments of the present disclosure is shown. Specifically, the wellbore 100 includes an open bore hole 102, a production tubing string 104, which may be a base pipe according to one or more embodiments, and a sand screen 106. While wellbore 100 is illustrated as being a substantially vertical, uncased well, it should be recognized that the subject disclosure is equally applicable for use in cased wellbores as well as in horizontal and/or inclined wellbores. The sand screen 106 includes a filter member 108 and a polymeric material, such as porous structural thermoset material 110 (e.g., porous elastomeric material) according to one or more embodiments of the present disclosure. The sand screen 106 is shown positioned in the wellbore 100 adjacent a producing formation 114. In some embodiments, the sand screen 106 (and/or the porous structural thermoset material 110) can be, for example, an annular shaped member that can be disposed about the production tubing string 104. In addition, according to one or more embodiments of the present disclosure, the porous structural thermoset material 110 may be the only filtration agent without the use of any filter member 108. In one or more embodiments of the present disclosure, the filter member 108 can be configured for additional structural support of the porous structural thermoset material 110.

Still referring to FIG. 1, in a well completion method according to one or more embodiments of the present disclosure, at least one base pipe (e.g., production tubing string 104) may be covered with the porous structural thermoset material 110 according to one or more embodiments of the present disclosure. In some embodiments, the porous structural thermoset material 110 covering the base pipe as the production tubing string 104 may be covered with a retainer (e.g., a film) before running the base pipe as the production tubing string 104 to a location in the wellbore 100. Upon exposure to a condition in the wellbore 100, the retainer may degrade and expose the porous structural thermoset material 110 to the wellbore fluids. In one or more embodiments, various methods are employed to trigger expansion of the porous structural thermoset material 110. As the porous structural thermoset material 110 expands into and fills the annulus, the porous structural thermoset material 110 conforms to a wall of the wellbore 100. Because the porous structural thermoset material 110 is able to conform to the wellbore 100 wall in this way and has a permeability that is about equivalent to or greater than the permeability of the surrounding formation, the porous structural thermoset material 110 is able to allow formation fluids into the base pipe as the production tubing string 104 while filter debris including sand from fluids from the producing formation 114. After the downhole operation is complete, the porous structural thermoset material 110 may be detached from the base pipe as the production tubing string 104, and the base pipe as the production tubing string 104 may be lifted out of the wellbore 100.

In this manner, the porous structural thermoset material 110 can have many beneficial applications for downhole tools in the oilfield; in particular, as a conformable sand screen as sand screen 106 used in oil and/or in gas operations. The porous structural thermoset material 110 can also be applied to/relevant to downhole tools involving a porous medium, such as for filtering or sealing applications. The porous structural thermoset material 110 can be porous, allowing downhole fluids to be produced through it. Simultaneously, the pores can be small enough that erosive sand particles can be captured before they enter the completions equipment. Once in the proper location downhole (e.g., in the wellbore 100 adjacent a producing formation 114), the porous structural thermoset material 110 can expand and conform to the wellbore 100. The high strength of the porous structural thermoset material 110 can also allow it to support the wellbore 100. This support can be especially important, for example, during drawdown, as suction created by pumps drawing fluids from the producing formation 114 can destabilize the producing formation 114. The structural strength of the porous structural thermoset material 110 can allow it, for example, to inhibit collapse during drawdown, ensuring sustained production from the well.

The high mechanical strength of the porous structural thermoset material 110 is a desirable property for use in oilfield operations, allowing porous structural thermoset material to withstand large loads. In addition to the porous structural thermoset material 110 having high strength, it can also have desirable chemical compatibility. In some embodiments, the porous structural thermoset material 110, which is formed by irreversible chemical reactions to generate a crosslinked structure that does not melt (also called thermosetting polymers, thermoset resins, or thermosetting resins) can include (but are not limited to) the following chemistries and variants: polyesters, cyanate esters, epoxies, phenolics, methacrylates, melamines, vinyl esters, bismaleimides, thermoset cyclic polyolefins, polyimides, and benzoxazines. Furthermore, the compounds used in the generation of the porous structural thermoset material 110 can be thermally stable to high temperatures and can be resistant to chemical attack.

The present “structural thermoset” material can be mechanically as a rigid thermosetting polymer where the non-porous, bulk material (when cured to form a densely crosslinked network) has a modulus (compressive, flexural, tensile, or elastic) of at least, for example, approximately 0.5 GPa below the glass transition temperature (Tg). In other embodiments, structural thermosets typically have a Tg above an ambient temperature (e.g., about 25° C.). This Tg can be the temperature at which the structural thermoset material transitions from its rigid state (i.e., a hard, glassy, brittle state) to a more flexible, rubbery state. The Tg can be selectable for a given structural thermoset material, based on the materials utilized in manufacturing the structural thermoset material, so as to allow for flexibility in selecting an onset Tg to correspond to an environment (i.e., bottom hole temperatures) that the structural thermoset material will be exposed to when deployed.

Additionally, some embodiments, the structural thermoset can be reinforced with fillers, such as ceramic or metallic particles of various types and/or geometries, to enhance the mechanical properties of the cured porous structural thermoset material 110. This can include spherical, non-spherical, or high aspect ratio silica (both crystalline and amorphous), boron nitride, aluminosilicate, alumina, aluminum nitride, and zirconium tungstate. Metallic reinforcements can include a variety of ferrous and non-ferrous, with preference to corrosion resistant materials (i.e. nickel alloys, stainless steels, etc.). In this manner, in some embodiments, the mechanical strength, thermal stability, and thermal conductivity of the porous structural thermoset material can be modified and improved through the addition of additional materials.

The porous structural thermoset material 110 can be made to be porous. The porous structure can have a variety of purposes, including: to allow fluid to pass through the material, to filter solid particles, and/or to create an interpenetrating composite network. In some embodiments, the interpenetrating thermoset composite network can have two or more materials with vastly different thermal, viscous, mechanical, electrical, or magnetic properties. For example, in the case of the porous structural thermoset material 110 used in a sand screen 106 (or as sand screen 106), the length scale of the pores of the porous structural thermoset material 110 could be larger in a radial direction relative to the length scale in the angular and axial directions. These differing length scales could facilitate high permeability in the radial direction while also supporting good sand retention properties. In some embodiments, a sand screen 106 made from the porous thermoset can be designed specifically for the size distribution of sands in the formation.

The pores of the porous structural thermoset material 110 can also have a non-uniform distribution. For example, a portion of the pores in the porous structural thermoset material 110 can have relatively smaller sizes, for example, to capture sand more efficiently, while another portion of the pores in the porous structural thermoset material 110 can have larger sizes relative to the smaller sized pores. These larger sized pores would allow the porous structural thermoset material 110 to be more permeable relative to a porous structural thermoset material 110 made with only smaller sized pores.

In the case of a sand screen 106, for example, smaller sized pores could be located close to the formation 114 (e.g., along an outer portion of the porous structural thermoset material 110 that would be disposed most closely to and/or in direct contact with the formation 114) to inhibit sand ingress, while larger sized pores can be disposed in an inner region of the porous structural thermoset material 110 (e.g., in an inner portion of the porous structural thermoset material 110 that would be disposed most closely to and/or in direct contact with the production tubing string 104) to facilitate higher permeability. The distribution of pore sizes could be bimodal (a mixture of small and large pores), trimodal, or simply monomodal with a large standard deviation.

While generation of the porous structural thermoset material 110 into a sand screen 106 is described, it should be noted that other devices and/or configurations are envisioned. For example, the porous structural thermoset material 110 can be shaped into forms for separation operations (e.g., as a separator used in separating oil and water), filtration operations (e.g., as a filter on a pump used in oil and gas operations, as an actuator or actuator device (e.g., to move to open and close a valve), or in similar operations.

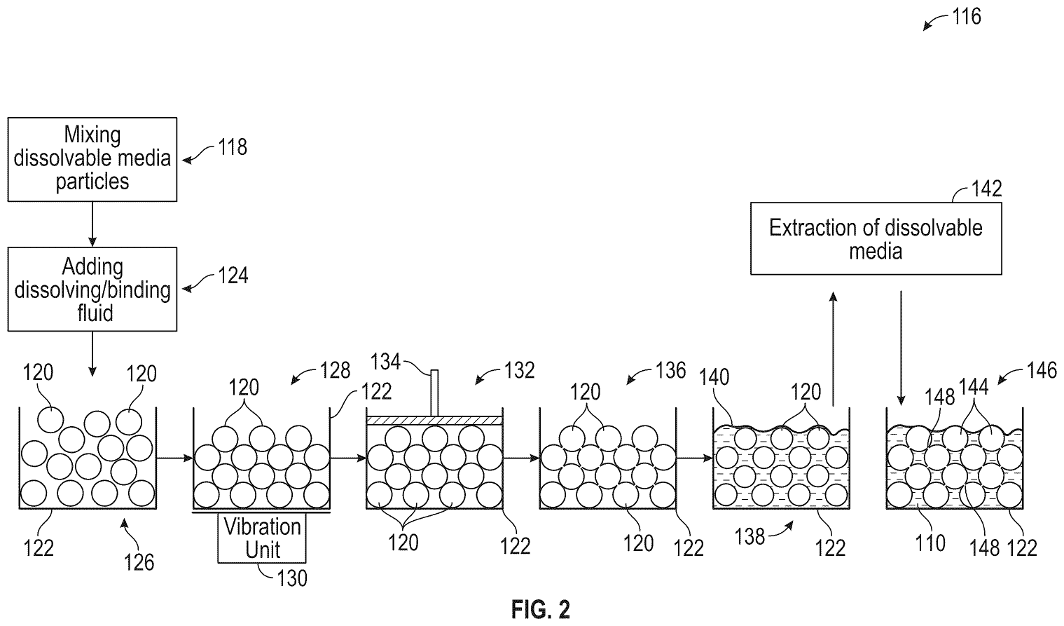

FIG. 2 illustrates a first embodiment of a method 116 of generating the porous structural thermoset material 110. It should be noted that in some embodiments, one or more blocks of method 116 may be selectively omitted. As will be described in greater detail, the method 116 illustrated in FIG. 2 illustrates creation of the porous structural thermoset material 110 via encapsulating a removable material with a structural thermoset material, such as, but not limited to, a structural thermoset polymer. For example, in block 118, particles of a removable material 120 can be mixed. The material selected as the removable material 120 can be chosen based on various properties, for example, its compressibility, the size of its particles, the manner in which it can be removed from a mold 122, and/or other characteristics.

In some embodiments, the removable material 120 can be a dissolvable material. For example, salt, sugar, polyvinyl alcohol (PVA), or another liquid soluble material can be used as the removable material 120. The salt selected can include Sodium Chloride, however, additionally and/or alternatively other salts can be utilized, for example, Magnesium Chloride, Calcium Chloride, Potassium Chloride, or other suitable salts. Likewise, numerous types of sugars can be utilized as the removable material 120. The removable material 120 can be chosen to be dissolvable in the presence of water or a different liquid (e.g., a solvent). In still other embodiments, removable material 120 can be a material that melts instead of one that dissolves in the presence of a liquid. For example, removable material 120 can be, for example, paraffin wax, carnauba wax, or another material that can be removable upon exposure to heat (e.g., temperatures up to or over approximately 85° C.). In further embodiments, the removable material 120 can be a solid material that sublimes upon exposure to heat (e.g., temperatures up to or over approximately 8520 C.). For example, naphthalene can be utilized as the removable material 120, since it sublimes at temperatures at or around 85° C. In some embodiments, the removable material 120 can be a mixture of two or more types of removable materials.

In block 124, a fluid may be applied to the removable material 120. In some embodiments, the fluid may be, for example, water or a liquid solvent. The liquid, for example, may be applied as a mist to the removable material 120. In some embodiments, the type and/or amount of fluid applied to the removable material 120 may be chosen based on the type of removable material 120. For example, an amount of fluid applied to the removable material 120 may be represented by, for example, approximately 5% by weight relative to the weight of the removable material 120, approximately 4% by weight relative to the weight of the removable material 120, approximately 3% by weight relative to the weight of the removable material 120, approximately 2% by weight relative to the weight of the removable material 120, approximately 1% by weight relative to the weight of the removable material 120, or another amount.

The fluid applied to the removable material 120 in block 124 may operate as dissolving and/or a binding fluid and can assist in compacting of the removable material in the mold 122. Likewise, adding the fluid to the to the removable material 120 in block 124 can assist in sintering (e.g., binding) of the particles of the removable material as well as improve the connectivity. An additional advantage of adding fluid to the removable material 120 in block 124 is that fluid can soften the particles of removable material 120. This can cause the removable material 120 particles to more easily deform when later placed under mechanical stresses, causing the point of contact between the removable particles (e.g., particles of the removable material 120) to expand to a region of contact. Mixing of the particles of the removable material 120 (e.g., in block 118) prior to application of the fluid in block 124 can assist in ensuring that the fluid is uniformly distributed into the particle in conjunction with block 124. Additionally, in some embodiments, subsequent to application of the liquid to the removable material 120, the mixture of liquid and removable material can be mixed prior to its loading into mold 122. In other embodiments, the mixing in block 118 and block 124 can be performed as a single mixing operation. Likewise, in still other embodiments, block 124 can be optional and the mixed removable material from block 118 can instead be loaded into the mold.

In block 126, particles of the removable material 120 can be loaded into the mold 122. As discussed above, the particles of the removable material 120 can be loaded into the mold 122 directly subsequent to block 118 or, in other embodiments, the particles of the removable material 120 can be loaded into the mold 122 directly subsequent to block 124. While the mold 122 is shown as an open mold, a closed mold can be used to facilitate resin injection (vs. potting in open mold). In some embodiments, mold 122 can be shaped and sized to fit within a desired sand screen 106 or the mold 122 can form a bulk porous structural thermoset material 110 shape, from which the form of the sand screen 106 is fabricated (e.g., via machining, cutting, etc.). Moreover, while generation of the porous structural thermoset material 110 into a sand screen 106 is described, it should be noted that other devices and/or configurations are envisioned. For example, the porous structural thermoset material 110 can be shaped into forms for separation operations (e.g., as a separator used in separating oil and water), filtration operations (e.g., as a filter on a pump used in oil and gas operations, as an actuator or actuator device (e.g., to move to open and close a valve), or in similar operations.

In block 128, mechanical vibration can be applied to the mold 122. Mechanical vibration can induce flow in granular media. The vibration breaks the particle agglomerates and allows other forces, such as gravitational forces, to dominate. For example, when particles of the removable material 120 are poured into the mold 122 in block 126, particle-particle interactions can keep the removable material 120 from fully settling in the mold 122. To aid the settling process, the mold 122 can be vibrated in conjunction with block 128.

The vibration in block 128 can occur while the particles of the removable material 120 are being poured into the mold 122, after the particles have been loaded into the mold 122, and/or intermittently while the pouring of the particles has paused. Vibration of the mold 122 improves the packing of the particles of the removable material 120. This increase in particle loading can result in higher porosity in the final material generated (i.e., the porous structural thermoset material 110) subsequent to later removal of the particles.

The vibration in block 128 can be provided by a vibration unit 130 coupled to the mold 122. The vibration unit 130 can be an electronic vibration unit or a pneumatic (air) vibration unit. The vibration unit 130 can operate to vibrate the mold 122 at a frequency (which may be preset or adjusted by a user) and the vibrations imparted by the vibration unit can, for example, break static bonds that build up between the removable material 120 and the mold 122 as well as, for example, particle-to-particle friction that occurs in the removable material 120. In operation, the vibration unit may improve the packing of the particles of the removable material 120 by, for example, approximately, 10%, 15%, 20%, 25%, 30%, 33%, 35%, 40%, 45, 50%, or another amount.

The vibrational energy supplied by the vibration unit 130 may be applied in a direction aligned with or perpendicular to the axis of the mold 122 and can be a continuous or pulsed input. The pre-treatment/pre-compaction with vibration facilitates particle rearrangement, minimizes the void space and aids in the uniform filling of the mold 122. This allows for subsequently applied compressive force to be transmitted uniformly during compaction. The selected frequency and amplitude of vibration required to achieve a desired fraction is dependent upon several factors e.g., shape and size of particles, mass of the dissolvable media, amount of binder fluid added, etc.

In conjunction with block 132, mechanical force can be applied to the removable material 120. To increase the loading of particles of the removable material 120 in a given volume of the mold 122, the particles can be pushed together with a mechanical force. This can assist in generating a desired network of removable particles, which can define a pore and pore throat network in the resulting porous structural thermoset material 110 that is generated. In one or more embodiments, in conjunction with block 132, the mechanical force applied can correspond to the removable material 120 being compressed in the mold 122 (e.g., into a network or a layer or another structure of compressed removable material 120) prior to any a thermoset composition being applied to the mold 122. This can be accomplished via use of a press 134 or another suitable device, for example, a rod. This compression process can increase the loading of removable material 120 in the mold 122 (i.e., the force of the compression compacts the particles and removes free space). The compression can also, for example, improve the porosity of the final part, as the particles of the removable material 120 are forced to have more contact with each other, ensuring that when the removable material 120 is removed, the pores generated in the porous structural thermoset material 110 from the removal of the removable material 120 are connected.

This compression process in block 132 can also alter the shape of the removable material 120, which can impact the shape of the pores generated in the porous structural thermoset material 110. That is, the pore size and/or shape in the resultant porous structural thermoset material 110 can be dictated by this compression process (e.g., the amount of compression applied, by applying different compressions to different portions of the removable material 120, etc.). For example, the compression process can be applied in different directions, for example, to provide anisotropic properties. Thus, in the case of manufacturing a sand screen 106 that is annular (i.e., has an annular shape), compression could be applied axially or radially, and the direction of compression applied would affect the pore morphology.

The amount of force applied in block 132 with respect to the compression process also influences the final soluble particle (i.e., removable material 120) volume fraction. For example, as more force is applied, for example, via the press 134, the volume fraction of the removable material 120 increased. For example, by varying the amount of compaction stress applied by the press, the volume fraction of the removable material 120 can compressed by, for example, approximately 40%, 45%, 50%, 55%, 60%, 65%, 70%, 75%, 80%, or another amount. Thus, a user can set a compression stress level of the press 134 to a predetermined level to generate a desired volume fraction of the removable material 120 in conjunction with block 132.

Initially as the removable material 120 is mechanically vibrated in block 128 (i.e., prior to compression in block 132), the agglomerates of the removal material are broken to achieve improved packing of the removable material in the mold. This operation increases the volume fraction of the particles of the removable material 120. As the removable material 120 is further compressed in block 136, the particles removable material 120 are made to contact each other forming a network with even better packing. This reduces the total volume occupied by the removable material in mold 122, however, it increases the volume fraction of particles due to the reduction in air trapped between the particles with efficient packing of particles of removable material 120.

Block 136 provides an example of the compression achieved as a result of block 128 and/or block 132. For example, the vibration of block 128 and the application of mechanical force in block 132 can increase the particle loading of the removable material 120 in the mold 122. Furthermore, the application of mechanical force in block 132 may deform the particles of the removable material 120. In conjunction with block 136, heat can be applied to the removable material 120. This heat can be imparted via, for example, an oven into which the mold 122 and the removable material 120 are placed for a set (i.e., predetermined) period of time at a set (i.e., predetermined) temperature. Additionally and/or alternatively, for example, heated fluid, such as heated air, can be provided directly to the removable material 120 and/or to the mold 122. Application of heat in conjunction with block 136 can operate to soften and/or provide localized dissolving of the particles of the removable material 120. This can aid in fusing of the particles of the removable material 120. Additionally, in embodiments where fluid was added to the removable material 120 in block 124, application of heat in block 136 can operate to remove any remaining fluid, thus rehardening the particles of the removable material 120 and causing the particles to fuse. Application of heat in as described above can result in deformation of the particles of removable material 120 (as illustrated in block 136) as well as the rehardening of the particles of the removable material after removal of the fluid previously applied in block 124.

In block 138, a thermoset composition 140 (e.g., a structural thermal mixture, structural thermoset formulation, structural thermoset precursor) can be added to the mold 122. The thermoset composition 140 can be added in an amount to wholly or partially cover the removable material 120. For example, the thermoset composition 140 can encapsulate and fill the interstices of the particles of the removable material 120. The thermoset composition 140 is an uncured version of the porous structural thermoset material 110. That is, in conjunction with block 138, the porous structural thermoset material 110 as a thermoset composition 140 may be in an uncured form when placed or otherwise added to the mold 122. Once added to the mold 122, the thermoset composition 140, for example, as a viscous liquid, may be cured (i.e., hardened). This curing can be accomplished by exposing the thermoset composition 140 to heat, radiation (e.g., ultraviolet light), pressure, a curing agent, and/or a catalyst. The curing of the thermoset composition 140 can result in an infusible and insoluble resultant porous elastomeric material as the porous structural thermoset material 110. In some embodiments, it may be advantageous to partially cure (e.g., as compared to fully curing) the thermoset composition 140, such that it is capable of conforming to irregularities in surfaces, shapes, and other features in a borehole.

Block 142 of FIG. 2 includes removal of the removable material 120. This removal can be performed by the application of a liquid (e.g., to dissolve the removable material 120), heat (e.g., to melt the removable material 120 or to sublime the removable material 120), an ultrasonic cleaner, and/or a catalyst to the removable material 120 and the porous structural thermoset material 110 in the mold 122. The removal process can be selected to match the material used as the removable material 120. In this manner, the removal process can include external stimulation that supports the removal of the particles of the removable material 120. Such external stimulation can include, for example, exposure to a solvent, a temperature change, a pressure change, agitation, and/or or ultrasonic waves. Upon removal of the removable material 120, pores 144 remain in the porous structural thermoset material 110.

As additionally illustrated in block 146, the pores 144 of the porous structural thermoset material 110 can be interconnected (e.g., as a network), allowing fluid to move between pores 144 through connecting pore throats 148 and ultimately through the entire material. This can assist in generating a network, which can define a pore 144 and pore throat 148 network in the resulting porous structural thermoset material 110 that is generated. In some embodiments, the pores 144 can be, for example, approximately between 1 micron and 1000 microns in diameter. The pore throats 148 range in size from approximately 0.1 microns to 100 microns. The pores 144 can be non-spherical and non-ellipsoidal, with each pore 144 potentially having multiple branches and/or nodes. The pores 144 could also be anisotropic. For example, in the case of the porous structural thermoset material 110 used in a sand screen 106 (or as sand screen 106), the length scale of the pore 144 could be larger in a radial direction relative to the length scale in the angular and axial directions. These differing length scales could facilitate high permeability in the radial direction while also supporting good sand retention properties. The dissolvable particle sizes and morphology are chosen in such a way to design the sizes of the pores 144 and pore throats 148. In some embodiments, a sand screen 106 made from the porous structural thermoset material 110 can be designed specifically for the size distribution of sands in the formation.

The 144 pore sizes can also have a non-uniform distribution. For example, a portion of the pores 144 in the porous structural thermoset material 110 can have relatively smaller sizes, for example, to capture sand more efficiently, while another portion of the pores 144 in the porous structural thermoset material 110 can have larger sizes relative to the smaller sized pores. These larger sized pores 144 would allow the porous structural thermoset material 110 to be more permeable relative to a porous structural thermoset material 110 made with only smaller sized pores 144. In some embodiments, different removable materials 120 (i.e., having different particle sizes) can be used, for example, in conjunction with one another to generate the porous structural thermoset material 110 having differently sized pores 144. In other embodiments, the removable material 120 can be selected as having a characteristic of different particle sizes therein, thus leading to different pore 144 sizes in the porous structural thermoset material 110 when the removable material 120 is removed.

In the case of a sand screen 106, for example, smaller sized pores 144 could be located close to the formation 114 (e.g., along an outer portion of the porous structural thermoset material 110 that would be disposed most closely to and/or in direct contact with the formation 114) to inhibit sand ingress, while larger sized pores 144 can be disposed in an inner region of the porous structural thermoset material 110 (e.g., in an inner portion of the porous structural thermoset material 110 that would be disposed most closely to and/or in direct contact with the production tubing string 104) to facilitate higher permeability. The distribution of pore sizes could be bimodal (a mixture of small and large pores 144), trimodal, or simply monomodal with a large standard deviation.

It should be noted that the above technique for forming the porous structural thermoset material 110 is one example of a manner in which the porous structural thermoset material 110 can be formed. Alternatively, other operations can be included. For example, subsequent to block 132, the press 134 (or another suitable device) can be applied to the removable material 120 to compress the removable material 120 to the bottom of the mold 122. Thereafter, additional removable material 120 can be added to the thermoset composition 140 in mold 122. Optionally, a second round of compression can be applied (e.g., via the press 134) and the removable material 120 can be formed into a second layer of particles of the removable material 120 disposed above a first layer of particles of the removable material 120. This process can be repeated to generate one or more additional layers of removable material 120. Thereafter, once a desired amount of removable material 120 has been added (with the thermoset composition 140 in its uncured state as a soft solid, viscous liquid, or non-viscous liquid), block 142 can be undertaken. In this manner, layered pores 144 can be generated in the porous structural thermoset material 110.

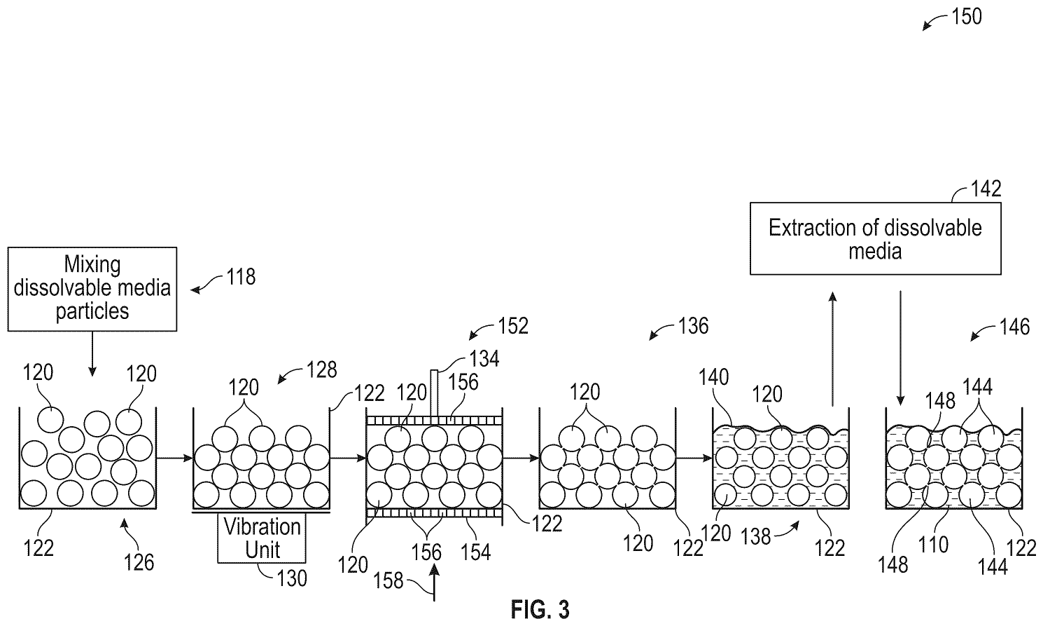

It is envisioned that other techniques for generating the porous structural thermoset material 110 are possible. For example, FIG. 3 illustrates a second embodiment of a method 150 of generating the porous structural thermoset material 110. It should be noted that in some embodiments, one or more blocks of method 150 may be selectively omitted. As will be described in greater detail, the method 150 illustrated in FIG. 3 illustrates creation of the porous structural thermoset material 110 via encapsulating a removable material with a structural thermoset material, such as, but not limited to, a structural thermoset polymer. For example, in block 118, particles of the removable material 120 can be mixed.

In block 126, particles of the removable material 120 can be loaded into the mold 122. While the mold 122 is shown as an open mold, a closed mold can be used to facilitate resin injection (vs. potting in open mold). In some embodiments, mold 122 can be shaped and sized to fit within a desired sand screen 106 or the mold 122 can form a bulk porous structural thermoset material 110 shape, from which the form of the sand screen 106 is fabricated (e.g., via machining, cutting, etc.). Moreover, while generation of the porous structural thermoset material 110 into a sand screen 106 is described, it should be noted that other devices and/or configurations are envisioned. For example, the porous structural thermoset material 110 can be shaped into forms for separation operations (e.g., as a separator used in separating oil and water), filtration operations (e.g., as a filter on a pump used in oil and gas operations, as an actuator or actuator device (e.g., to move to open and close a valve), or in similar operations.

In block 128, mechanical vibration can be applied to the mold 122. Mechanical vibration can induce flow in granular media. The vibration disturbs particle-particle interactions and allows other forces, such as gravitational forces, to dominate. For example, when particles of the removable material 120 are poured into the mold 122 in block 126, particle-particle interactions can keep the removable material 120 from fully settling in the mold 122. To aid the settling process, the mold 122 can be vibrated in conjunction with block 128.

The vibration in block 128 can occur while the particles of the removable material 120 are being poured into the mold 122, after the particles have been loaded into the mold 122, and/or intermittently while the pouring of the particles has paused. Vibration of the mold 122 improves the packing of the particles of the removable material 120. This increase in particle loading can result in higher porosity in the final material generated (i.e., the porous structural thermoset material 110) subsequent to later removal of the particles. As previously discussed, the vibration in block 128 can be provided by a vibration unit 130 coupled to the mold 122.

In conjunction with block 152, mechanical force can be applied to the removable material 120. To increase the loading of particles of the removable material 120 in a given volume of the mold 122, the particles can be pushed together with a mechanical force. This can assist in generating a desired network of removable particles, which can define a pore and pore throat network in the resulting porous structural thermoset material 110 that is generated. In one or more embodiments, in conjunction with block 152, the mechanical force applied can correspond to the removable material 120 being compressed in the mold 122 (e.g., into a network or a layer or another structure of compressed removable material 120) prior to any a thermoset composition being applied to the mold 122. This can be accomplished via use of a press 134 or another suitable device, for example, a rod. This compression process can increase the loading of removable material 120 in the mold 122 (i.e., the force of the compression compacts the particles and removes free space). The compression can also, for example, improve the porosity of the final part, as the particles of the removable material 120 are forced to have more contact with each other, ensuring that when the removable material 120 is removed, the pores generated in the porous structural thermoset material 110 from the removal of the removable material 120 are connected.

This compression process in block 152 can also alter the shape of the removable material 120, which can impact the shape of the pores generated in the porous structural thermoset material 110. That is, the pore size and/or shape in the resultant porous structural thermoset material 110 can be dictated by this compression process (e.g., the amount of compression applied, by applying different compressions to different portions of the removable material 120, etc.). For example, the compression process can be applied in different directions, for example, to provide anisotropic properties. Thus, in the case of manufacturing a sand screen 106 that is annular (i.e., has an annular shape), compression could be applied axially or radially, and the direction of compression applied would affect the pore morphology.

The amount of force applied in block 152 with respect to the compression process also influences the final soluble particle (i.e., removable material 120) volume fraction. For example, as more force is applied, for example, via the press 134, the volume fraction of the removable material 120 increased. For example, by varying the amount of compaction stress applied by the press, the volume fraction of the removable material 120 can compressed by, for example, approximately 40%, 45%, 50%, 55%, 60%, 65%, 70%, 75%, 80%, or another amount. Thus, a user can set a compression stress level of the press 134 to a predetermined level to generate a desired volume fraction of the removable material 120 in conjunction with block 152.

Dissolving fluid could potentially be added during the compaction process of block or during the vibration in block 128. For example, while the particles of the removable material 120 are being compacted, either with mechanical vibration in block 128 or with mechanical force in block 152, a dissolving fluid, for example, water or a liquid solvent, could be pumped into the mold 122. For example, if water were the dissolving fluid, steam 158 could be passed through a bottom portion 154 of the mold 122 during the compaction process of block 152. The bottom portion 154 of the mold 122 could have apertures 156 therein to allow the steam 158 to pass therethrough. Additionally, the press 134 could likewise include apertures 156 therein to allow the steam 158 to pass therethrough. The combination of water and elevated temperature as steam can operate to soften the particles of the removable material 120 and aid in the sintering process.

An amount of fluid applied to the removable material in conjunction with block 152 (or block 128) may be represented by, for example, approximately 5% by weight relative to the weight of the removable material 120, approximately 4% by weight relative to the weight of the removable material 120, approximately 3% by weight relative to the weight of the removable material 120, approximately 2% by weight relative to the weight of the removable material 120, approximately 1% by weight relative to the weight of the removable material 120, or another amount.

The fluid applied to the removable material 120 in block 152 (or block 128) may operate as dissolving and/or a binding fluid and can assist in compacting of the removable material in the mold 122. Likewise, adding the fluid to the to the removable material 120 in in block 152 (or block 128) can assist in sintering (e.g., binding) of the particles of the removable material as well as improve the connectivity. An additional advantage of adding fluid to the removable material 120 in block 152 (or block 128) is that fluid can soften the particles of removable material 120. This can cause the removable material 120 particles to more easily deform when placed under mechanical stresses, causing the point of contact between the removable particles (e.g., particles of the removable material 120) to expand to a region of contact. Additionally, in conjunction with block 152 (or block 128), the apertures 156 of the bottom portion 154 of the mold 122 can be covered, for example, by a cover, such as a cap or a lid.

Block 136 provides an example of the compression achieved as a result of block 128 and/or block 152. For example, the vibration of block 128 and the application of mechanical force in block 152 can increase the particle loading of the removable material 120 in the mold 122. Furthermore, the application of mechanical force in block 152 may deform the particles of the removable material 120. In conjunction with block 136, heat can be applied to the removable material 120. Application of heat in conjunction with block 136 can operate to soften and/or partially melt the particles of the removable material 120. This can aid in fusing of the particles of the removable material 120. Additionally, application of heat in block 136 can operate to remove any remaining fluid applied in block 152 (or block 128), thus rehardening the particles of the removable material 120 and causing the particles to fuse. Application of heat in as described above can result in deformation of the particles of removable material 120 (as illustrated in block 136) as well as the rehardening of the particles of the removable material after removal of the fluid previously applied in block 124.

In block 138, a thermoset composition 140 (e.g., a structural thermal mixture, structural thermoset formulation, structural thermoset precursor) can be added to the mold 122. The thermoset composition 140 can be added in an amount to wholly or partially cover the removable material 120. For example, the thermoset composition 140 can encapsulate and fill the interstices of the particles of the removable material 120. The thermoset composition 140 is an uncured version of the porous structural thermoset material 110. That is, in conjunction with block 138, the porous structural thermoset material 110 as a thermoset composition 140 may be in an uncured form when placed or otherwise added to the mold 122. Once added to the mold 122, the thermoset composition 140, for example, as a viscous liquid, may be cured (i.e., hardened). This curing can be accomplished by exposing the thermoset composition 140 to heat, radiation (e.g., ultraviolet light), pressure, a curing agent, and/or a catalyst. The curing of the thermoset composition 140 can result in an infusible and insoluble resultant porous elastomeric material as the porous structural thermoset material 110. In some embodiments, it may be advantageous to partially cure (e.g., as compared to fully curing) the thermoset composition 140, such that it is capable of conforming to irregularities in surfaces, shapes, and other features in a borehole.

Block 142 of FIG. 3 includes removal of the removable material 120. This removal can be performed by the application of a liquid (e.g., to dissolve the removable material 120), heat (e.g., to melt the removable material 120 or to sublime the removable material 120), an ultrasonic cleaner, and/or a catalyst to the removable material 120 and the porous structural thermoset material 110 in the mold 122. The removal process can be selected to match the material used as the removable material 120. In this manner, the removal process can include external stimulation that supports the removal of the particles of the removable material 120. Such external stimulation can include, for example, exposure to a solvent, a temperature change, a pressure change, agitation, and/or or ultrasonic waves. Upon removal of the removable material 120, pores 144 remain in the porous structural thermoset material 110.

As additionally illustrated in block 146, the pores 144 of the porous structural thermoset material 110 can be interconnected (e.g., as a network), allowing fluid to move between pores 144 through connecting pore throats 148 and ultimately through the entire material. This can assist in generating a network, which can define a pore 144 and pore throat 148 network in the resulting porous structural thermoset material 110 that is generated. In some embodiments, the pores 144 can be, for example, approximately between 1 micron and 1000 microns in diameter. The pore throats 148 range in size from approximately 0.1 microns to 100 microns. The pores 144 can be non-spherical and non-ellipsoidal, with each pore 144 potentially having multiple branches and/or nodes. The pores 144 could also be anisotropic. For example, in the case of the porous structural thermoset material 110 used in a sand screen 106 (or as sand screen 106), the length scale of the pore 144 could be larger in a radial direction relative to the length scale in the angular and axial directions. These differing length scales could facilitate high permeability in the radial direction while also supporting good sand retention properties. The dissolvable particle sizes and morphology are chosen in such a way to design the sizes of the pores 144 and pore throats 148. In some embodiments, a sand screen 106 made from the porous structural thermoset material 110 can be designed specifically for the size distribution of sands in the formation.

The pore 144 sizes can also have a non-uniform distribution. For example, a portion of the pores 144 in the porous structural thermoset material 110 can have relatively smaller sizes, for example, to capture sand more efficiently, while another portion of the pores 144 in the porous structural thermoset material 110 can have larger sizes relative to the smaller sized pores. These larger sized pores 144 would allow the porous structural thermoset material 110 to be more permeable relative to a porous structural thermoset material 110 made with only smaller sized pores 144. In some embodiments, different removable materials 120 (i.e., having different particle sizes) can be used, for example, in conjunction with one another to generate the porous structural thermoset material 110 having differently sized pores 144. In other embodiments, the removable material 120 can be selected as having a characteristic of different particle sizes therein, thus leading to different pore 144 sizes in the porous structural thermoset material 110 when the removable material 120 is removed.

In the case of a sand screen 106, for example, smaller sized pores 144 could be located close to the formation 114 (e.g., along an outer portion of the porous structural thermoset material 110 that would be disposed most closely to and/or in direct contact with the formation 114) to inhibit sand ingress, while larger sized pores 144 can be disposed in an inner region of the porous structural thermoset material 110 (e.g., in an inner portion of the porous structural thermoset material 110 that would be disposed most closely to and/or in direct contact with the production tubing string 104) to facilitate higher permeability. The distribution of pore sizes could be bimodal (a mixture of small and large pores 144), trimodal, or simply monomodal with a large standard deviation.

It should be noted that the above technique for forming the porous structural thermoset material 110 is one example of a manner in which the porous structural thermoset material 110 can be formed. Alternatively, other operations can be included. For example, subsequent to block 132, the press 134 (or another suitable device) can be applied to the removable material 120 to compress the removable material 120 to the bottom of the mold 122. Thereafter, additional removable material 120 can be added to the thermoset composition 140 in mold 122. Optionally, a second round of compression can be applied (e.g., via the press 134) and the removable material 120 can be formed into a second layer of particles of the removable material 120 disposed above a first layer of particles of the removable material 120. This process can be repeated to generate one or more additional layers of removable material 120. Thereafter, once a desired amount of removable material 120 has been added (with the thermoset composition 140 in its uncured state as a soft solid, viscous liquid, or non-viscous liquid), block 142 can be undertaken. In this manner, layered pores 144 can be generated in the porous structural thermoset material 110.

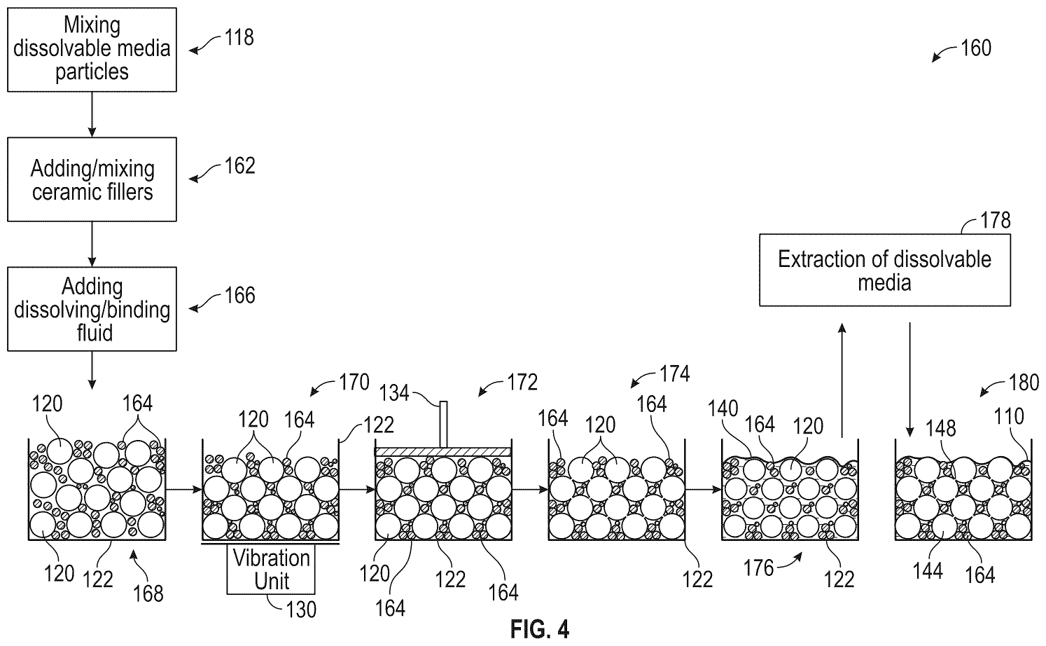

Additional techniques for generating the porous structural thermoset material 110 are envisioned. For example, FIG. 4 illustrates a third embodiment of a method 160 of generating the porous structural thermoset material 110. It should be noted that in some embodiments, one or more blocks of method 160 may be selectively omitted. As will be described in greater detail, the method 160 illustrated in FIG. 4 illustrates creation of the porous structural thermoset material 110 via encapsulating a removable material with a structural thermoset material, such as, but not limited to, a structural thermoset polymer.

Method 160 is similar to the approaches discussed above with respect to method 116 of FIG. 2 and method 150 of FIG. 3. That is, method 160 involves creating a pore network/structure of dissolvable particles (particles of the removable material 120) using one or more of the sintering techniques discussed above with respect to method 116 of FIG. 2 and method 150 of FIG. 3. This structure of dissolvable particles in the mold 122 essentially represents a negative of the pore network in the final porous product (i.e., porous structural thermoset material 110). The thermoset composition 140 (e.g., thermoset resin material) is injected into the mold 122, thereby forcing the thermoset composition 140 to flow through the interstices of the particles of the removable material 120. Narrower and convoluted interstices can result in the use of higher injection pressures to ensure complete encapsulation of the particles of the removable material 120, for example, in block 138 of method 116 of FIG. 2 and method 150 of FIG. 3. This in turn requires a good/strong bond between the particles created during the sintering processes of method 116 of FIG. 2 and method 150 of FIG. 3, since a weaker bond would break and thereby completely encapsulate particles of the removable material 120. This may lead to a result in which particles of the removable material 120 cannot be completely extracted to create the porous structural thermoset material 110. This, in turn, can affect the pore network, porosity, and permeability of the final product (i.e., the porous structural thermoset material 110).

Thus, in conjunction with method 160 of FIG. 4, filler particles 164 may be introduced to improve the mechanical properties (e.g., modulus, strength, etc.) of the final porous product (i.e., the porous structural thermoset material 110). However, the filler particles 164 tend to increase the viscosity of the resin material (i.e., the thermoset composition 140), which in turn can lead to the use of higher injection pressures to completely encapsulate the network/structure of the particles of the removable material 120. A potential solution to address this issue is described below and involves mixing the filler particles (i.e., filler material) with the particles of the removable material 120 prior to any encapsulation process.

As illustrated in FIG. 4, method 160 includes block 118 in which particles of the removable material 120 can be mixed. The material selected as the removable material 120 can be chosen based on various properties, for example, its compressibility, the size of its particles, the manner in which it can be removed from a mold 122, and/or other characteristics.

In some embodiments, the removable material 120 can be a dissolvable material. For example, salt, sugar, polyvinyl alcohol (PVA), or another liquid soluble material can be used as the removable material 120. The salt selected can include Sodium Chloride, however, additionally and/or alternatively other salts can be utilized, for example, Magnesium Chloride, Calcium Chloride, Potassium Chloride, or other suitable salts. Likewise, numerous types of sugars can be utilized as the removable material 120. The removable material 120 can be chosen to be dissolvable in the presence of water or a different liquid (e.g., a solvent). In still other embodiments, removable material 120 can be a material that melts instead of one that dissolves in the presence of a liquid. For example, removable material 120 can be, for example, paraffin wax, carnauba wax, or another material that can be removable upon exposure to heat (e.g., temperatures up to or over approximately 85° C.). In further embodiments, the removable material 120 can be a solid material that sublimes upon exposure to heat (e.g., temperatures up to or over approximately 8520 C.). For example, naphthalene can be utilized as the removable material 120, since it sublimes at temperatures at or around 85° C. In some embodiments, the removable material 120 can be a mixture of two or more types of removable materials.

In block 162, fillers, such as ceramic or metallic particles of various types and/or geometries, can be introduced to the removable material 120. The fillers can include filler particles 164 that operate to enhance the mechanical properties of the cured porous structural thermoset material 110. The filler particles 164 can include spherical, non-spherical, or high aspect ratio silica (both crystalline and amorphous), boron nitride, aluminosilicate, alumina, aluminum nitride, and zirconium tungstate. In some embodiments, the mechanical strength, thermal stability, and thermal conductivity of the porous structural thermoset material 110 can be modified and improved through the addition of the filler particles 164. As part of block 162, the filler particles 164 and the removable material 120 can be mixed. Mixing of particles of the removable material 120 with the filler particles 164 in block 162 can assist in distributing the filler particles 164 and the particles of the removable material 120. In some embodiments, the mixing in block 118 and block 162 can be performed as a single mixing operation.

In block 166, a fluid may be applied to the filler particles 164 and the removable material 120. In some embodiments, the fluid may be, for example, water or a liquid solvent. The liquid, for example, may be applied as a mist to the filler particles 164 and the removable material 120. In some embodiments, the type and/or amount of fluid applied to the filler particles 164 and the removable material 120 may be chosen based on the type of removable material 120. For example, an amount of fluid applied to the filler particles 164 and the removable material 120 may be represented by, for example, approximately 5% by weight relative to the weight of the removable material 120, approximately 4% by weight relative to the weight of the removable material 120, approximately 3% by weight relative to the weight of the removable material 120, approximately 2% by weight relative to the weight of the removable material 120, approximately 1% by weight relative to the weight of the removable material 120, or another amount.

The fluid applied to the filler particles 164 and the removable material 120 in block 166 may operate as dissolving and/or a binding fluid and can assist in compacting of the removable material in the mold 122. Likewise, adding the fluid to the to the filler particles 164 and the removable material 120 in block 124 can assist in sintering (e.g., binding) of the particles of the removable material 120 as well as improve the connectivity. An additional advantage of adding fluid to the removable material 120 in block 166 is that fluid can soften the particles of removable material 120. This can cause the removable material 120 particles to more easily deform when later placed under mechanical stresses, causing the point of contact between the removable particles (e.g., particles of the removable material 120) to expand to a region of contact. Mixing of the filler particles 164 and the particles of the removable material 120 (e.g., in block 162) prior to application of the fluid in block 124 can assist in ensuring that the fluid is uniformly distributed into the particle in conjunction with block 166. Additionally, in some embodiments, subsequent to application of the liquid to the removable material 120, the mixture of liquid, the filler particles 164, and the removable material 120 can be mixed prior to its loading into mold 122.

In block 168, the filler particles 164 and the particles of the removable material 120 can be loaded into the mold 122. As discussed above, the filler particles 164 and the particles of the removable material 120 can be loaded into the mold 122 directly subsequent to block 166. While the mold 122 is shown as an open mold, a closed mold can be used to facilitate resin injection (vs. potting in open mold). In some embodiments, mold 122 can be shaped and sized to fit within a desired sand screen 106 or the mold 122 can form a bulk porous structural thermoset material 110 shape, from which the form of the sand screen 106 is fabricated (e.g., via machining, cutting, etc.). Moreover, while generation of the porous structural thermoset material 110 into a sand screen 106 is described, it should be noted that other devices and/or configurations are envisioned. For example, the porous structural thermoset material 110 can be shaped into forms for separation operations (e.g., as a separator used in separating oil and water), filtration operations (e.g., as a filter on a pump used in oil and gas operations, as an actuator or actuator device (e.g., to move to open and close a valve), or in similar operations.

In block 170, mechanical vibration can be applied to the mold 122. Mechanical vibration can induce flow in granular media. The vibration disturbs particle-particle interactions and allows other forces, such as gravitational forces, to dominate. For example, when particles of the filler particles 164 and the removable material 120 are poured into the mold 122 in block 168, particle-particle interactions can keep the filler particles 164 and the removable material 120 from fully settling in the mold 122. To aid the settling process, the mold 122 can be vibrated in conjunction with block 170.

The vibration in block 170 can occur while the filler particles 164 and particles of the removable material 120 are being poured into the mold 122, after the particles have been loaded into the mold 122, and/or intermittently while the pouring of the particles has paused. Vibration of the mold 122 improves the packing of the particles of the filler particles 164 and the removable material 120. This increase in particle loading can result in higher porosity in the final material generated (i.e., the porous structural thermoset material 110) subsequent to later removal of the particles of the removable material.

The vibration in block 170 can be provided by a vibration unit 130 coupled to the mold 122. The vibration unit 130 can be an electronic vibration unit or a pneumatic (air) vibration unit. The vibration unit 130 can operate to vibrate the mold 122 at a frequency (which may be preset or adjusted by a user) and the vibrations imparted by the vibration unit can, for example, break static bonds that build up between the filler particles 164 and the removable material 120 and the mold 122 as well as, for example, particle-to-particle friction that occurs in the filler particles 164 and the removable material 120. In operation, the vibration unit may improve the packing of the particles of the removable material 120 by, for example, approximately, 10%, 15%, 20%, 25%, 30%, 33%, 35%, 40%, 45, 50%, or another amount.

The vibrational energy supplied by the vibration unit 130 may be applied in a direction aligned with or perpendicular to the axis of the mold 122 and can be a continuous or pulsed input. The pre-treatment/pre-compaction with vibration facilitates particle rearrangement, minimizes the void space and aids in the uniform filling of the mold 122. This allows for subsequently applied compressive force to be transmitted uniformly during compaction. The selected frequency and amplitude of vibration required to achieve a desired fraction is dependent upon several factors e.g., shape and size of particles, mass of the dissolvable media, amount of binder fluid added, etc.

In conjunction with block 172, mechanical force can be applied to the filler particles 164 and the removable material 120. To increase the loading of the filler particles 164 and particles of the removable material 120 in a given volume of the mold 122, the particles can be pushed together with a mechanical force. This can assist in generating a desired network of removable particles (e.g., particles of the removable material 120), which can define a pore and pore throat network in the resulting porous structural thermoset material 110 that is generated. In one or more embodiments, in conjunction with block 132, the mechanical force applied can correspond to the filler particles 164 and the removable material 120 being compressed in the mold 122 (e.g., into a network or a layer or another structure of compressed removable material 120) prior to a thermoset composition being applied to the mold 122. This can be accomplished via use of a press 134 or another suitable device, for example, a rod. This compression process can increase the loading of the filler particles 164 and the removable material 120 in the mold 122 (i.e., the force of the compression compacts the particles and removes free space). The compression can also, for example, improve the porosity of the final part, as the particles of the removable material 120 are forced to have more contact with each other, ensuring that when the removable material 120 is removed, the pores generated in the porous structural thermoset material 110 from the removal of the removable material 120 are connected.

This compression process in block 172 can also alter the shape of the removable material 120, which can impact the shape of the pores generated in the porous structural thermoset material 110. That is, the pore size and/or shape in the resultant porous structural thermoset material 110 can be dictated by this compression process (e.g., the amount of compression applied, by applying different compressions to different portions of the removable material 120, etc.). For example, the compression process can be applied in different directions, for example, to provide anisotropic properties. Thus, in the case of manufacturing a sand screen 106 that is annular (i.e., has an annular shape), compression could be applied axially or radially, and the direction of compression applied would affect the pore morphology.

The amount of force applied in block 132 with respect to the compression process also influences the final soluble particle (i.e., removable material 120) volume fraction. For example, as more force is applied, for example, via the press 134, the volume fraction of the removable material 120 increased. For example, by varying the amount of compaction stress applied by the press, the volume fraction of the removable material 120 can compressed by, for example, approximately 40%, 45%, 50%, 55%, 60%, 65%, 70%, 75%, 80%, or another amount. Thus, a user can set a compression stress level of the press 134 to a predetermined level to generate a desired volume fraction of the removable material 120 in conjunction with block 132.

Block 174 provides an example of the compression achieved as a result of block 170 and/or block 172. For example, the vibration of block 170 and the application of mechanical force in block 172 can increase the particle loading of the removable material 120 in the mold 122. Furthermore, the application of mechanical force in block 172 may deform the particles of the removable material 120. In conjunction with block 174, heat can be applied to the filler particles 164 and the removable material 120. This heat can be imparted via, for example, an oven into which the mold 122 and the filler particles 164 and the removable material 120 therein is placed for a set (i.e., predetermined) period of time at a set (i.e., predetermined) temperature. Additionally and/or alternatively, for example, heated fluid, such as heated air, can be provided directly to the filler particles 164 and the removable material 120 and/or to the mold 122. Application of heat in conjunction with block 136 can operate to soften and/or partially melt the particles of the removable material 120. This can aid in fusing of the particles of the removable material 120. Additionally, in embodiments where fluid was added to the filler particles 164 and the removable material 120 in block 124, application of heat in block 136 can operate to remove any remaining fluid, thus rehardening the particles of the removable material 120 and causing the particles to fuse. Application of heat in as described above can result in deformation of the particles of removable material 120 (as illustrated in block 174) as well as the rehardening of the particles of the removable material 120 after removal of the fluid previously applied in block 166.

After sintering in conjunction with block 166, block 172, and block 174, the filler particles 164 and the removable material 120 can be prepped for injection of thermoset media (i.e., a thermoset composition 140) by controlling environmental conditions (e.g., temperature, pressure, etc.). In block 176, a thermoset composition 140 (e.g., a structural thermal mixture, structural thermoset formulation, structural thermoset precursor) can be added to the mold 122. The thermoset composition 140 can be added in an amount to wholly or partially cover the filler particles 164 and the removable material 120. For example, the thermoset composition 140 can encapsulate and fill the interstices of the particles of the removable material 120. The thermoset composition 140 is an uncured version of the porous structural thermoset material 110. That is, in conjunction with block 176, the porous structural thermoset material 110 as a thermoset composition 140 may be in an uncured form when placed or otherwise added to the mold 122. Once added to the mold 122, the thermoset composition 140, for example, as a viscous liquid, may be cured (i.e., hardened). This curing can be accomplished by exposing the thermoset composition 140 to heat, radiation (e.g., ultraviolet light), pressure, a curing agent, and/or a catalyst. The curing of the thermoset composition 140 can result in an infusible and insoluble resultant porous elastomeric material as the porous structural thermoset material 110. In some embodiments, it may be advantageous to partially cure (e.g., as compared to fully curing) the thermoset composition 140, such that it is capable of conforming to irregularities in surfaces, shapes, and other features in a borehole.

Block 178 of FIG. 4 includes removal of the removable material 120. This removal can be performed by the application of a liquid (e.g., to dissolve the removable material 120), heat (e.g., to melt the removable material 120 or to sublime the removable material 120), an ultrasonic cleaner, and/or a catalyst to the removable material 120 and the porous structural thermoset material 110 in the mold 122. The removal process can be selected to match the material used as the removable material 120. In this manner, the removal process can include external stimulation that supports the removal of the particles of the removable material 120. Such external stimulation can include, for example, exposure to a solvent, a temperature change, a pressure change, agitation, and/or or ultrasonic waves. Upon removal of the removable material 120, pores 144 remain in the porous structural thermoset material 110.

As additionally illustrated in block 180, the pores 144 of the porous structural thermoset material 110 can be interconnected (e.g., as a network), allowing fluid to move between pores 144 through connecting pore throats 148 and ultimately through the entire material. This can assist in generating a network, which can define a pore 144 and pore throat 148 network in the resulting porous structural thermoset material 110 that is generated. In some embodiments, the pores 144 can be, for example, approximately between 1 micron and 1000 microns in diameter. The pore throats 148 range in size from approximately 0.1 microns to 100 microns. The pores 144 can be non-spherical and non-ellipsoidal, with each pore 144 potentially having multiple branches and/or nodes. The pores 144 could also be anisotropic. For example, in the case of the porous structural thermoset material 110 used in a sand screen 106 (or as sand screen 106), the length scale of the pore 144 could be larger in a radial direction relative to the length scale in the angular and axial directions. These differing length scales could facilitate high permeability in the radial direction while also supporting good sand retention properties. The dissolvable particle sizes and morphology are chosen in such a way to design the sizes of the pores 144 and pore throats 148. In some embodiments, a sand screen 106 made from the porous structural thermoset material 110 can be designed specifically for the size distribution of sands in the formation.

The pore 144 sizes can also have a non-uniform distribution. For example, a portion of the pores 144 in the porous structural thermoset material 110 can have relatively smaller sizes, for example, to capture sand more efficiently, while another portion of the pores 144 in the porous structural thermoset material 110 can have larger sizes relative to the smaller sized pores. These larger sized pores 144 would allow the porous structural thermoset material 110 to be more permeable relative to a porous structural thermoset material 110 made with only smaller sized pores 144. In some embodiments, different removable materials 120 (i.e., having different particle sizes) can be used, for example, in conjunction with one another to generate the porous structural thermoset material 110 having differently sized pores 144. In other embodiments, the removable material 120 can be selected as having a characteristic of different particle sizes therein, thus leading to different pore 144 sizes in the porous structural thermoset material 110 when the removable material 120 is removed.

In the case of a sand screen 106, for example, smaller sized pores 144 could be located close to the formation 114 (e.g., along an outer portion of the porous structural thermoset material 110 that would be disposed most closely to and/or in direct contact with the formation 114) to inhibit sand ingress, while larger sized pores 144 can be disposed in an inner region of the porous structural thermoset material 110 (e.g., in an inner portion of the porous structural thermoset material 110 that would be disposed most closely to and/or in direct contact with the production tubing string 104) to facilitate higher permeability. The distribution of pore sizes could be bimodal (a mixture of small and large pores 144), trimodal, or simply monomodal with a large standard deviation.

It should be noted that the above technique for forming the porous structural thermoset material 110 is one example of a manner in which the porous structural thermoset material 110 can be formed. Alternatively, other operations can be included. For example, subsequent to block 172, the press 134 (or another suitable device) can be applied to the removable material 120 to compress the removable material 120 to the bottom of the mold 122. Thereafter, additional removable material 120 can be added to the thermoset composition 140 in mold 122. Optionally, a second round of compression can be applied (e.g., via the press 134) and the removable material 120 can be formed into a second layer of particles of the removable material 120 disposed above a first layer of particles of the removable material 120. This process can be repeated to generate one or more additional layers of removable material 120. Thereafter, once a desired amount of removable material 120 has been added (with the thermoset composition 140 in its uncured state as a soft solid, viscous liquid, or non-viscous liquid), block 142 can be undertaken. In this manner, layered pores 144 can be generated in the porous structural thermoset material 110.

Method 160 of FIG. 4 can provide particular advantages. For example, it is possible to achieve higher loadings of reinforcements, and the non-dissolvable filler material (i.e., filler particles 164) can help to keep clumping of the mixtures of dissolvable media (i.e., the removable material 120) to a minimum (particularly in the case that water is added to facilitate the sintering process).

In one or more embodiments, the sand screen 106 is customized to the formation 114. By altering the removable material 120 the pore 144 size and distribution of the final sand screen 106 can be adjusted. The pore 144 size may be customized to the sand particle sizes for each well, allowing for increased permeability while still ensuring sand retention performance and formation stability. Similarly, the properties of the porous structural thermoset material 110, such as, but not limited to material strength, can be adjusted based on the well conditions, the expected load from the formation 114 onto the sand screen 106, and/or other factors.

The technical effect of the disclosed embodiments includes improvements in making and using a porous structural thermoset material 110. In some embodiments, this porous structural thermoset material 110 can generated through removal of removable material 120 that was present in the thermoset composition 140 in its uncured state. The removable material 120 can be subjected to a dual-mode approach employing a combination of mechanical vibration and compressive force to a desired packing fraction. Removal of the removable material 120 generate pores in the porous structural thermoset material 110. In this configuration, the porous structural thermoset material 110 can be particularly useful as a sand screen 106. Techniques additionally include a dual-mode approach employing a combination of mechanical vibration and compressive force may to achieve a desired packing fraction.

The subject matter described in detail above may be defined as set forth below.

A method includes dispensing a removable material into a mold, providing mechanical vibration to the mold to compact the removable material into compacted removable material having a first particle volume fraction, providing a mechanical force to the compacted removable material to generate a compressed removable material having a second particle volume fraction that is more than the first particle volume fraction, dispensing a structural thermoset material into the mold, curing the structural thermoset material having particles of the compressed removable material disposed therein to generate a cured structural thermoset material having the particles of the compressed removable material disposed therein, and removing the particles of the compressed removable material from the cured structural thermoset material to generate a porous structural thermoset material.

The method of the preceding clause, wherein dispensing the removable material into the mold is performed prior to dispensing the structural thermoset material into the mold.

The method any preceding clause, comprising adding a fluid to the removable material.

The method any preceding clause, comprising adding the fluid to the removable material prior to dispensing the removable material into the mold.

The method any preceding clause, comprising applying heat to the compressed removable material to remove the fluid from the removable material.

The method any preceding clause, comprising applying the heat to the compressed removable material prior to dispensing the structural thermoset material into the mold.

The method any preceding clause, comprising adding a fluid to the compacted removable material.

The method any preceding clause, comprising adding the fluid to the compacted removable material in conjunction with providing the mechanical force to the compacted removable material.

The method any preceding clause, comprising adding the fluid to the compacted removable material prior to providing the mechanical force to the compacted removable material.

The method any preceding clause, comprising adding steam as the fluid added to the compacted removable material in conjunction with providing the mechanical force.

The method any preceding clause, wherein dispensing the removable material into the mold comprises dispensing the removable material into an annular shaped mold.

A device includes a porous structural thermoset material shaped into an annular shape, wherein the porous structural thermoset material includes pores formed via removal of a removable material compressed to have a predetermined particle volume fraction and filler particles disposed in regions of the porous structural thermoset material adjacent to the pores.

The device of the preceding clause, comprising a sand screen comprising the porous structural thermoset material.

The device of any preceding clause, wherein the filler particles comprise one or more of silica, boron nitride, aluminosilicate, alumina, aluminum nitride, or zirconium tungstate.

The device of any preceding clause, wherein the porous structural thermoset material comprises pore throats connecting the pores, wherein the pores and the pore throats comprise a network configured to allow fluid to move through the porous structural thermoset material.

A method includes dispensing a removable material and filler particles into a mold, providing mechanical vibration to the mold to compact the removable material and the filler particles into compacted material having a first particle volume fraction, providing a mechanical force to the compacted material to generate a compressed material having a second particle volume fraction that is more than the first particle volume fraction, dispensing a structural thermoset material into the mold, curing the structural thermoset material having particles of the removable material as a portion of the compressed material disposed therein to generate a cured structural thermoset material having the particles of the removable material and the filler particles disposed therein, and removing the particles of the removable material from the cured structural thermoset material to generate a porous structural thermoset material having the filler particles disposed therein.

The method of the preceding clause, wherein dispensing the removable material and the filler particles into the mold is performed prior to dispensing the structural thermoset material into the mold.

The method any preceding clause, comprising adding a fluid to the removable material and the filler particles.

The method any preceding clause, comprising adding the fluid to the removable material and the filler particles prior to dispensing the removable material and the filler particles into the mold.

The method any preceding clause, comprising applying heat to the compressed material to remove the fluid from the removable material prior to dispensing the structural thermoset material into the mold.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or degree.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosure and various embodiments with various modifications as are suited to the particular use contemplated.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A method, comprising:
dispensing a removable material into a mold;
providing mechanical vibration to the mold to compact the removable material into compacted removable material having a first particle volume fraction;
providing a mechanical force to the compacted removable material to generate a compressed removable material having a second particle volume fraction that is more than the first particle volume fraction;
dispensing a structural thermoset material into the mold;
curing the structural thermoset material having particles of the compressed removable material disposed therein to generate a cured structural thermoset material having the particles of the compressed removable material disposed therein; and
removing the particles of the compressed removable material from the cured structural thermoset material to generate a porous structural thermoset material.

2. The method of claim 1, wherein dispensing the removable material into the mold is performed prior to dispensing the structural thermoset material into the mold.

3. The method of claim 2, comprising adding a fluid to the removable material.

4. The method of claim 3, comprising adding the fluid to the removable material prior to dispensing the removable material into the mold.

5. The method of claim 4, comprising applying heat to the compressed removable material to remove the fluid from the removable material.

6. The method of claim 5, comprising applying the heat to the compressed removable material prior to dispensing the structural thermoset material into the mold.

7. The method of claim 2, comprising adding a fluid to the compacted removable material.

8. The method of claim 7, comprising adding the fluid to the compacted removable material in conjunction with providing the mechanical force to the compacted removable material.

9. The method of claim 7, comprising adding the fluid to the compacted removable material prior to providing the mechanical force to the compacted removable material.

10. The method of claim 7, comprising adding steam as the fluid added to the compacted removable material in conjunction with providing the mechanical force.

11. The method of claim 1, wherein dispensing the removable material into the mold comprises dispensing the removable material into an annular shaped mold.

12. A device, comprising:
a porous structural thermoset material shaped into an annular shape, wherein the porous structural thermoset material comprises:
pores formed via removal of a removable material compressed to have a predetermined particle volume fraction; and
filler particles disposed in regions of the porous structural thermoset material adjacent to the pores.

13. The device of claim 12, comprising a sand screen comprising the porous structural thermoset material.

14. The device of claim 12, wherein the filler particles comprise one or more of silica, boron nitride, aluminosilicate, alumina, aluminum nitride, or zirconium tungstate.

15. The device of claim 12, wherein the porous structural thermoset material comprises pore throats connecting the pores, wherein the pores and the pore throats comprise a network configured to allow fluid to move through the porous structural thermoset material.

16. A method, comprising:
dispensing a removable material and filler particles into a mold;
providing mechanical vibration to the mold to compact the removable material and the filler particles into compacted material having a first particle volume fraction;
providing a mechanical force to the compacted material to generate a compressed material having a second particle volume fraction that is more than the first particle volume fraction;
dispensing a structural thermoset material into the mold;
curing the structural thermoset material having particles of the removable material as a portion of the compressed material disposed therein to generate a cured structural thermoset material having the particles of the removable material and the filler particles disposed therein; and
removing the particles of the removable material from the cured structural thermoset material to generate a porous structural thermoset material having the filler particles disposed therein.

17. The method of claim 16, wherein dispensing the removable material and the filler particles into the mold is performed prior to dispensing the structural thermoset material into the mold.

18. The method of claim 17, comprising adding a fluid to the removable material and the filler particles.

19. The method of claim 18, comprising adding the fluid to the removable material and the filler particles prior to dispensing the removable material and the filler particles into the mold.

20. The method of claim 19, comprising applying heat to the compressed material to remove the fluid from the removable material prior to dispensing the structural thermoset material into the mold.
